(19) United States
(12) Patent Application Publication
(10) Pub. No.: US 2025/0354514 A1
(43) Pub. Date: Nov. 20, 2025

(54) POWERTRAIN FOR A UTILITY VEHICLE

(71) Applicant: Polaris Industries Inc., Medina, MN (US)

(72) Inventors: Steven M. Tittl, Wyoming, MN (US); Andrew C. Schleif, Wyoming, MN (US); Stephen L. Nelson, Wyoming, MN (US); Kevin J. Rodel, Isanti, MN (US); William L. Barbrey, Lino Lakes, MN (US); Paul W. Barton, Warwickshire (GB); Oliver Young, Birmingham (GB); Andrew PH Statham, Leicestershire (GB)

(21) Appl. No.: 19/289,288

(22) Filed: Aug. 4, 2025

Related U.S. Application Data
(62) Division of application No. 18/207,565, filed on Jun. 8, 2023, now Pat. No. 12,385,429.
(60) Provisional application No. 63/351,574, filed on Jun. 13, 2022.

(51) Int. Cl. F02B 37/02; B60K 13/02; B60K 13/04; F02B 29/04

(52) U.S. Cl. CPC F02B 37/02; B60K 13/02; B60K 13/04; F02B 29/0425; F02B 29/0481; B60Y 2200/20

(57) ABSTRACT

A utility vehicle including a plurality of ground-engaging members, a frame supported by the ground-engaging members, and a powertrain assembly supported by the frame and including an engine supported by the frame, the engine including an exhaust side and a turbocharger operably coupled to the engine, the turbocharger having a turbine housing supporting a turbine and a compressor housing supporting a compressor, the turbocharger being positioned on the exhaust side of the engine and rearward of the engine, a space between the turbocharger and the engine being less than 9 inches.

### CROSS-REFERENCE TO RELATED APPLICATION

The present application claims priority to U.S. Patent Application Ser. No. 63/351,574, filed Jun. 13, 2022, the complete disclosure of which is incorporated herein by reference.

### FIELD OF THE DISCLOSURE

The present invention relates generally to a vehicle and, in particular, to a vehicle with a turbocharged powertrain assembly.

### BACKGROUND THE DISCLOSURE

Generally, all-terrain vehicles (“ATVs”) and utility vehicles (“UVs”) are used to carry one or more passengers and a small amount of cargo over a variety of terrains.

Power output and the powertrain system is important for providing such vehicles with the ability to move across various terrain. What are needed are improvements to the powertrain system for assuring increased and reliable power.

### SUMMARY OF THE DISCLOSURE

A utility vehicle is provided with an engine and turbocharger positioned on the hot side of the engine.

According to one example, a utility vehicle includes a plurality of ground-engaging members, a frame supported by the ground-engaging members, and a powertrain assembly supported by the frame and including an engine supported by the frame, the engine including an exhaust side and a turbocharger operably coupled to the engine, the turbocharger having a turbine housing supporting a turbine and a compressor housing supporting a compressor, the turbocharger being positioned on the exhaust side of the engine and rearward of the engine, a space between the turbocharger and the engine being less than 9 inches.

According to another example, the utility vehicle further includes an operator area and a cargo area supported by the frame, wherein the turbocharger is positioned vertically below at least a portion of the cargo area.

According to another example, the powertrain assembly of the utility vehicle further includes a transmission operably coupled to the engine, wherein the turbocharger is positioned vertically higher than the transmission.

According to another example, the muffler of the utility vehicle is coupled to the engine via an exhaust conduit, the exhaust conduit being less than two feet.

According to another example, the powertrain assembly of the utility vehicle further includes an exhaust conduit positioned fluidically between the engine and the muffler, and wherein the frame defines a frame envelope, the turbocharger being positioned within the frame envelope and the exhaust conduit extending at least partially outside of the frame envelope.

According to another example, the powertrain assembly of the utility vehicle further includes a continuously variable transmission (CVT) operably coupled to the engine, the turbocharger being positioned laterally adjacent to the CVT.

According to another example, the turbocharger of the utility vehicle is outside an envelope defined by the CVT.

According to another example, the powertrain assembly of the utility vehicle further includes an intercooler, the intercooler being positioned laterally adjacent to the turbocharger.

According to another example, the powertrain assembly of the utility vehicle further includes an air intake and an air filter fluidically coupled to the engine via the turbocharger, the air filter being positioned on a non-exhaust side of the engine.

According to another example, a portion of the intercooler of the utility vehicle includes an air intake and an air exhaust, the air exhaust being positioned longitudinally forward of the turbocharger.

According to another example, the powertrain assembly of the utility vehicle further includes an engine intake manifold operably coupled to the engine, and wherein the air exhaust of the intercooler is laterally adjacent at least a portion of the engine intake manifold.

A utility vehicle is provided with an engine and an oil management system.

According to one example, a utility vehicle includes a plurality of ground-engaging members, a frame supported by the ground-engaging members, and a powertrain assembly supported by the frame and including an engine supported by the frame a turbocharger operably coupled to the engine, and an oil management system fluidically coupled to the engine and the turbocharger, the oil management system including an oil pan defining a staging reservoir, a staging oil pick up member including an opening positioned proximate the staging reservoir, an engine oil pump fluidically coupled to the staging oil pick up member and operable to pump oil from the staging reservoir to the engine, and a turbo drain through which oil from the turbocharger is operable to drain from the turbocharger, the turbo drain operable to deliver the oil to be picked up by the staging oil pick up member.

According to another example, the oil management system of the utility vehicle is a wet sump.

According to another example, the staging oil pickup member of the utility vehicle includes an auxiliary opening, the auxiliary opening being fluidically coupled to the turbo drain.

According to another example, the oil management system of the utility vehicle includes a channel in fluid communication with the turbo drain and the staging oil pick up member at the second opening, such that oil is drained from the turbocharger directly to the auxiliary opening of the staging oil pickup member.

According to another example, the oil management system of the utility vehicle includes a delivery reservoir adjacent the staging reservoir and a delivery oil pickup member with an opening proximate the delivery reservoir, wherein the oil pump is operable to deliver oil from the staging reservoir to the delivery reservoir.

According to another example, the oil management system of the utility vehicle includes a de-aerating member fluidically between the staging reservoir and the delivery reservoir.

According to another example, the oil management system of the utility vehicle includes a delivery reservoir cover, wherein the delivery reservoir is a pressurized chamber when the delivery reservoir cover is installed and the oil pump is active.

According to another example, the staging oil pickup member of the utility vehicle is positioned vertically above a portion of the staging reservoir.

According to another example, the portion of the staging reservoir above which the staging oil pickup member of the utility vehicle is positioned defines a low pressure zone during operation.

According to another example, the turbocharger of the utility vehicle drains into the low pressure zone of the staging reservoir.

An off-road recreational vehicle is provided with an engine and a water cooling system.

According to one example, an off-road recreational vehicle includes a plurality of ground-engaging members, a frame supported by the ground-engaging members, and a powertrain assembly supported by the frame and including an engine supported by the frame an air intake system fluidically coupled to the engine to provide air to the engine and including a throttle blade positioned fluidically upstream from the engine, and a water cooling system including a nozzle interfacing with the air intake system upstream from the throttle blade.

According to another example, the nozzle of the off-road recreational vehicle interfaces with the air intake system within 8 inches from the throttle blade upstream from the throttle blade.

According to another example, the nozzle of the off-road recreational vehicle is operable to atomize water.

According to another example, the nozzle of the off-road recreational vehicle is positioned perpendicular to flow of air through the air intake system.

According to another example, the water cooling system of the off-road recreational vehicle further includes a controller operable to activate the nozzle in predetermined conditions.

According to another example, the predetermined conditions of the off-road recreational vehicle include one of high temperatures, wide open throttle, and increased power demands.

According to another example, the water cooling system of the off-road recreational vehicle further includes a water reservoir supported by the frame.

According to another example, the off-road recreational vehicle further includes a continuously variable transmission (CVT), wherein the CVT is fluidically coupled to the water reservoir.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a front perspective view of a utility vehicle of the present disclosure;

FIG. 2 is a rear perspective view of the utility vehicle of FIG. 1;

FIG. 3 is a left side view of the utility vehicle of FIG. 1;

FIG. 4 is a right side view of the utility vehicle of FIG. 1;

FIG. 5 is a top view of the utility vehicle of FIG. 1;

FIG. 6 is a front side view of the utility vehicle of FIG. 1;

FIG. 7 is a rear side view of the utility vehicle of FIG. 1;

FIG. 8 is a perspective view of a powertrain assembly of the vehicle of FIG. 1;

FIG. 9 is a side view of the powertrain assembly of FIG. 8;

FIG. 10 is a top view of the powertrain assembly of FIG. 8;

FIG. 11 is a view of a powertrain assembly having an engine in an lateral or east-west configuration;

FIG. 12 is a view of a powertrain assembly having an engine in a longitudinal or north-south configuration;

FIG. 13 is a view of an alternative powertrain assembly having an engine in a longitudinal or north-south configuration;

FIG. 14 is a top perspective view of a powertrain assembly with an engine and a turbocharger;

FIG. 15 is a side view of the engine and turbocharger of FIG. 14;

FIG. 16 is a top view of the engine and turbocharger of FIG. 14;

FIG. 17 is a bottom perspective view of the engine and turbocharger of FIG. 14;

FIG. 18 is a bottom perspective view of an oil management system of an engine with a drain line from a turbocharger;

FIG. 19 is a bottom view of the oil management system of FIG. 18;

FIG. 20 is a top perspective view of the oil management system of FIG. 18;

FIG. 21 is a top perspective view of an interior of an oil pan of the oil management system of FIG. 18;

Fig, 22 is a side perspective view of the oil management system of FIG. 18;

FIG. 23 is a side section view of the oil management system of FIG. 18;

FIG. 24 is a front section view of the oil management system of FIG. 18;

FIG. 25 is a top view of the oil management system of FIG. 18;

FIG. 26 is a front section view of reservoirs and pickup members of the oil management system of FIG. 18;

FIG. 27 is a section view of the oil management system of FIG. 18 positioned in a condition of high angularity;

FIG. 28 is a section view of the oil management system of FIG. 18 positioned in another condition of high angularity;

FIG. 29 is a view of an alternative embodiment of an oil management system;

FIG. 30 is a section view of another alternative embodiment of an oil management system;

FIG. 31 is a top view of an oil pan of the oil management system of FIG. 30;

FIG. 32 is a schematic of a water injection system; and

Fig, 33 is an alternative schematic of a water injection system.

Corresponding reference characters indicate corresponding parts throughout the several views. Unless stated otherwise the drawings are proportional.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a utility vehicle, it should be understood that the features disclosed herein may have application to other types of vehicles such as other all-terrain vehicles, motorcycles, snowmobiles, and golf carts.

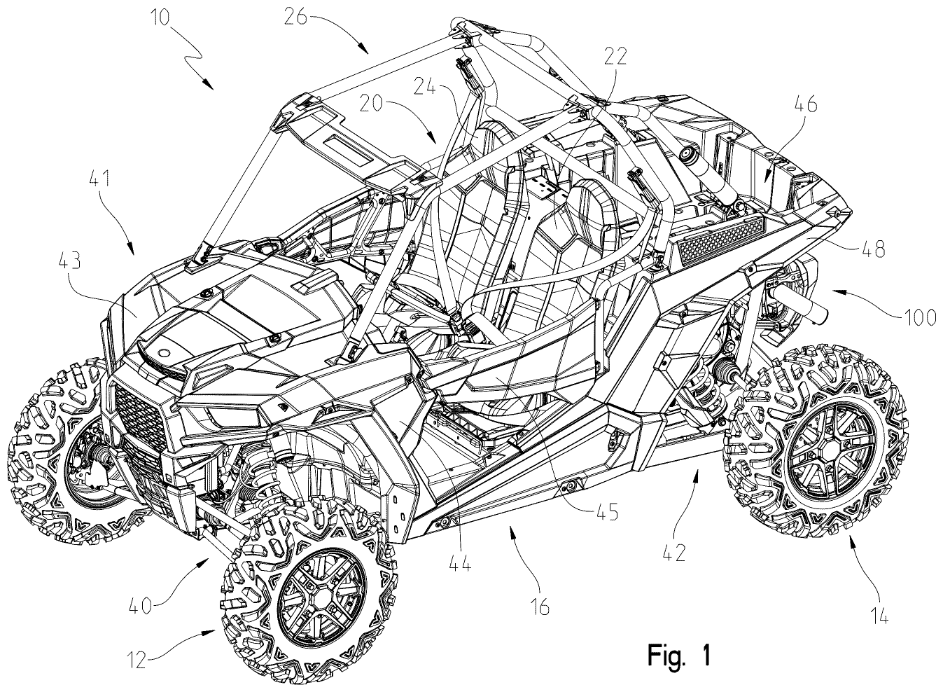

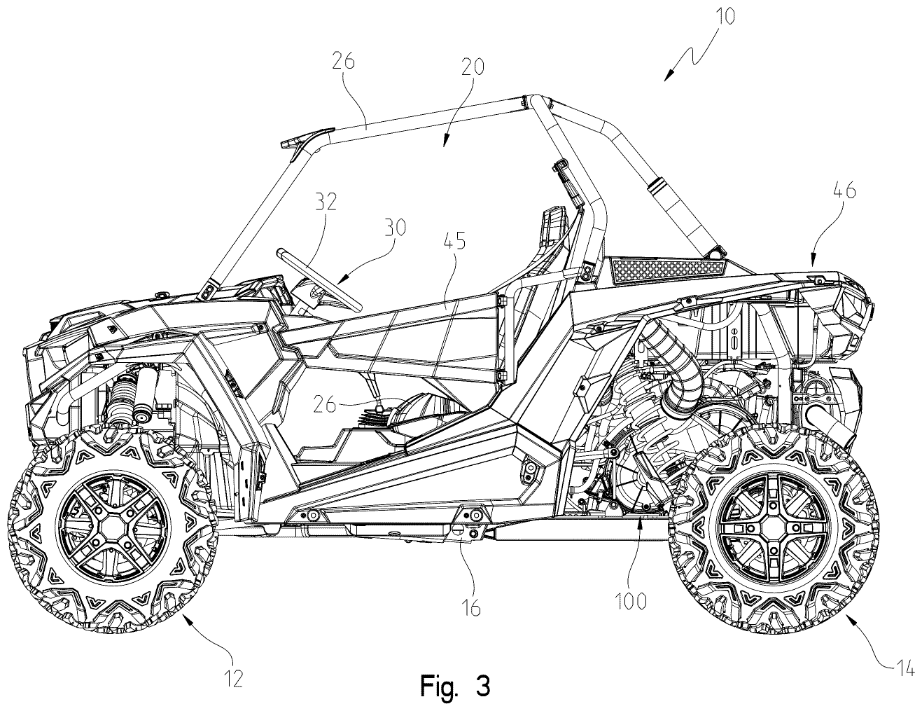

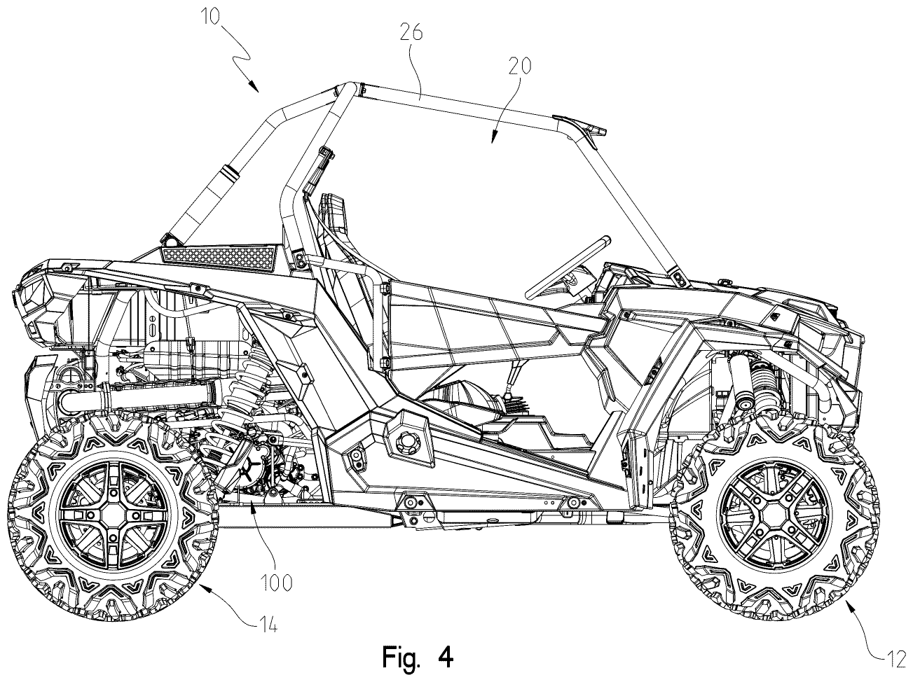

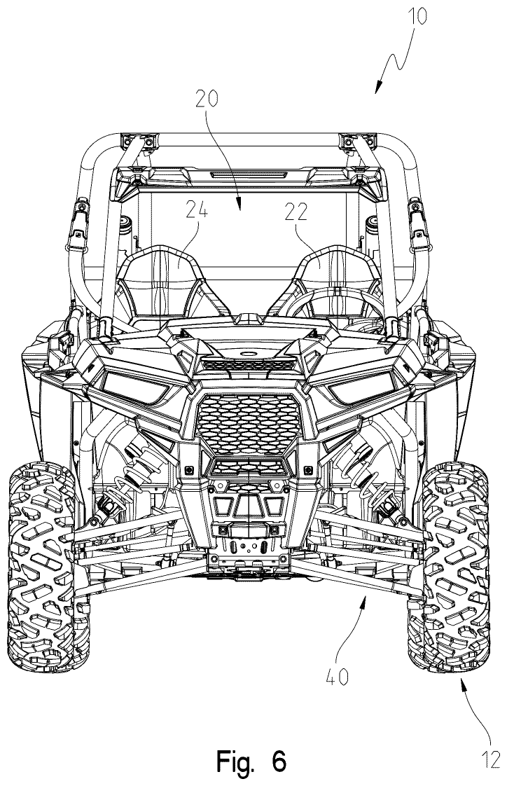

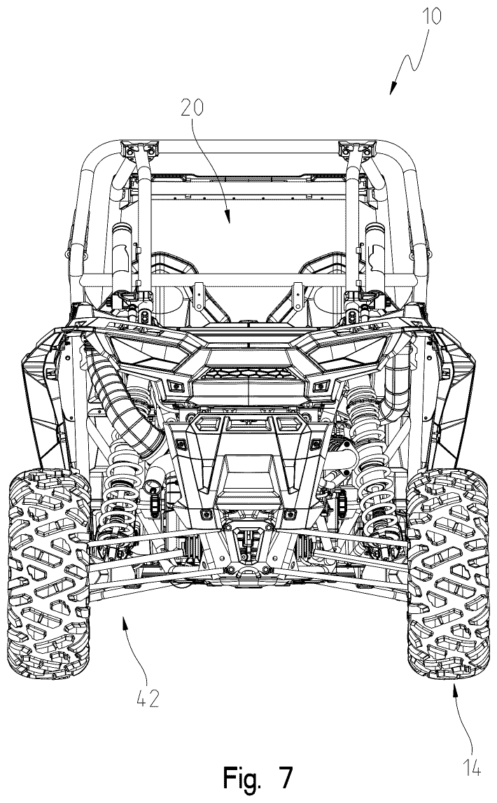

With reference first to FIGS. 1-7, the vehicle of the present invention will be described. As shown, a vehicle 10 is generally depicted which includes front ground-engaging members 12 and rear ground-engaging members 14. The ground-engaging members 12, 14 support a vehicle frame 16 (FIG. 3), which supports an operator or seating area 20 comprised of a driver's seat 22 and a passenger seat 24. A cab frame 26 generally extends over the seating area 20. As best shown in FIG. 3, the vehicle 10 further includes a steering assembly 30 for steering the front ground-engaging members 12 whereby the steering assembly 30 includes a steering wheel 32 which could be both tiltable and longitudinally movable.

In some embodiments, the vehicle 10 is a four-wheel drive vehicle. As shown, the vehicle 10 may also include an outer body 41 including a hood 43, side panels 44, doors 45, a cargo area 46 (e.g., a utility bed), and rear panels 48, which are illustrated throughout FIGS. 1-7. The vehicle 10 further includes a front suspension 40 and a rear suspension 42.

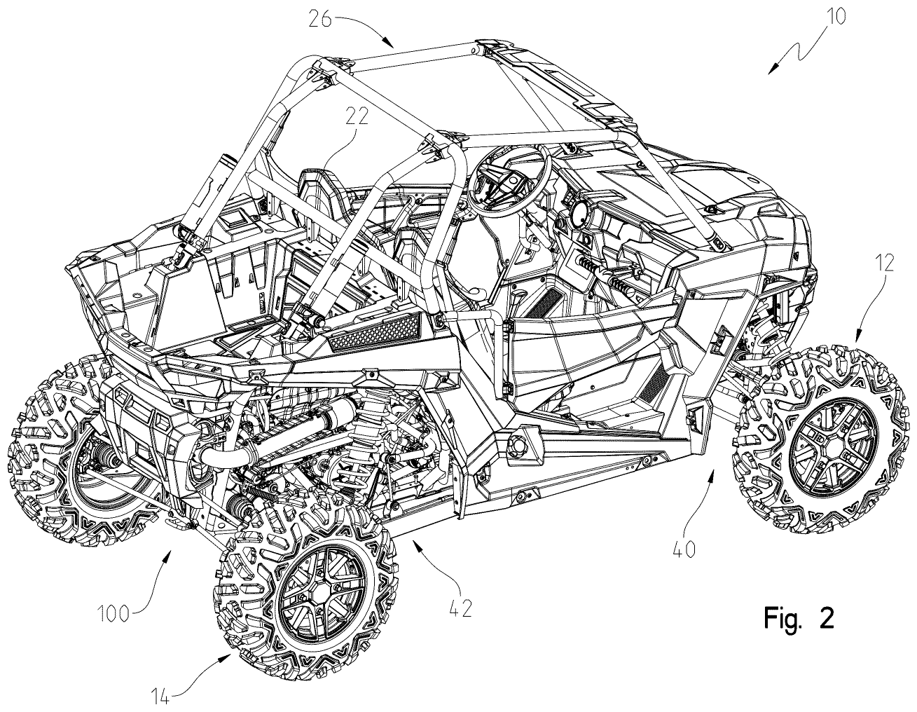

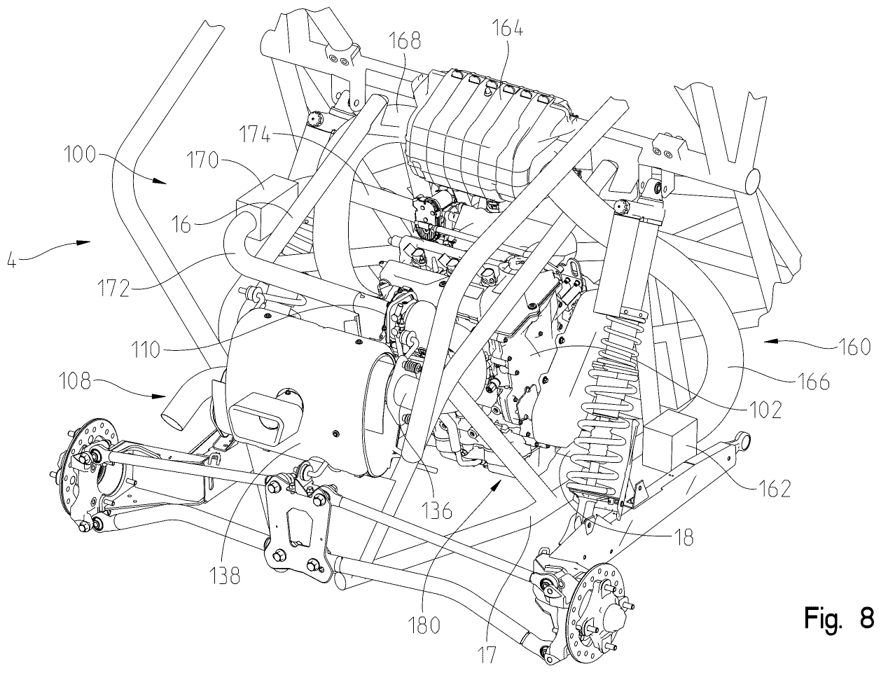

As seen in FIGS. 2-4 and 8-13, the vehicle 10 include a powertrain assembly 100. The component parts of the powertrain assembly 100 are discussed hereafter in greater detail with respect to FIGS. 8-10. Illustratively, the powertrain assembly 100 is comprised of an engine 102, a transmission 124 (e.g., a continuously variable transmission (CVT) 104, and/or a shiftable transmission 106), an exhaust assembly 108, and a turbocharger 110. The powertrain assembly 100 is supported by the vehicle frame 16. The powertrain assembly 100 described herein may be further configured as shown in U.S. patent application Ser. No. 16/875,448 with a filing date of May 15, 2020 and/or U.S. patent application Ser. No. 16/875,494 with a filing date of May 15, 2020, the subject matter of which are incorporated herein by reference in their entireties.

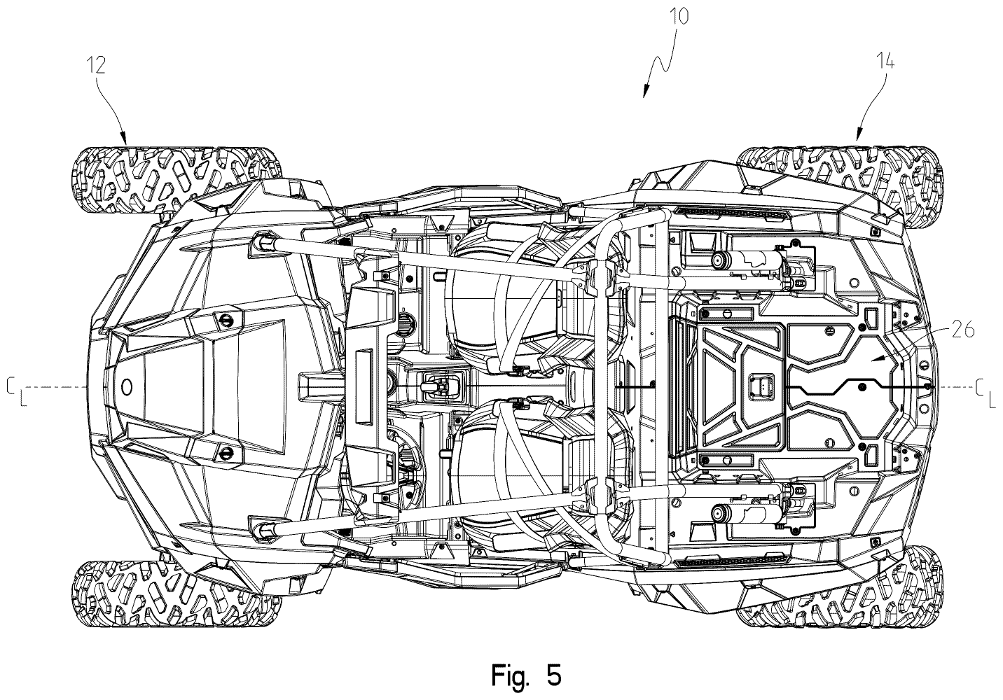

With reference now to FIGS. 8-10, the powertrain assembly 100 will be described in greater detail. The powertrain assembly 100 provides power to the ground-engaging members 12, 14 of the vehicle 10 (FIGS. 1-7). The powertrain assembly 100 is supported on at least longitudinal frame members 17 and an engine mount 18 of the vehicle frame 16. In one embodiment, the longitudinal frame members 17 are generally parallel to a centerline C_{L} of the vehicle 10 (FIG. 5) and the engine mount 18 extends transversely to the centerline C_{L} and the longitudinal frame members 17.

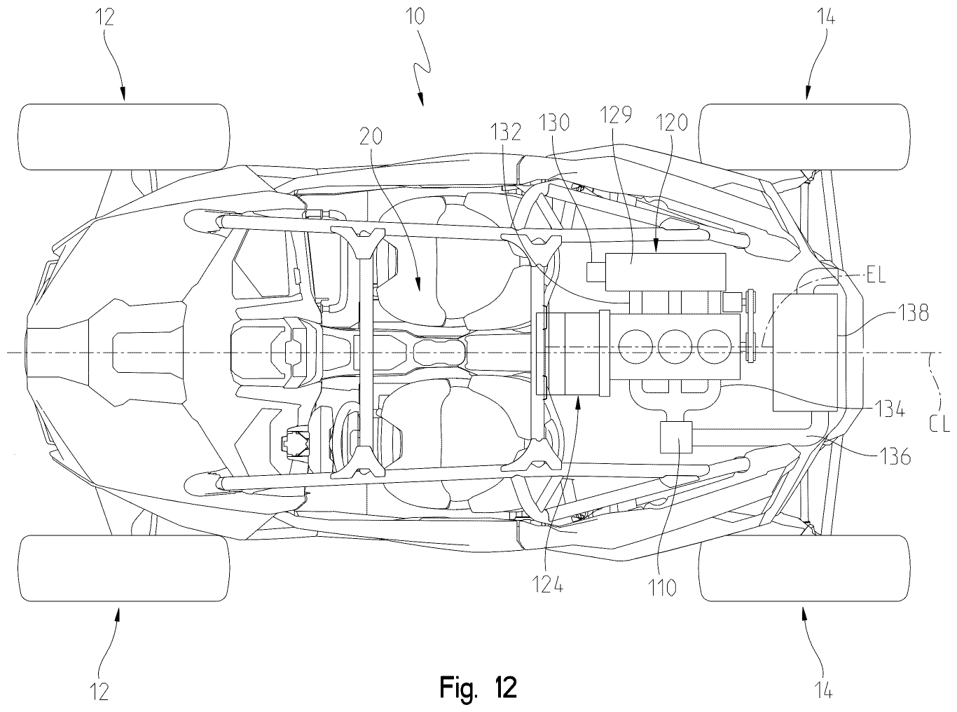

Referring to FIGS. 11-13, the engine 102 is positioned at the rear of the vehicle 10 behind the seating area 20. The engine 102 includes an engine or cylinder block 112 with at least one cylinder 114 (e.g., including a twin cylinder configuration, three cylinder configuration, other cylinder configurations). Illustratively, the engine 102 is an in-line, three-cylinder engine having a first, second, and a third cylinder 114. In addition to the engine 102, the powertrain assembly 100 includes an engine intake manifold assembly 120 providing air to the engine 102, the exhaust assembly 108 routing exhaust from the engine 102 out of vehicle 10, the transmission 124 operably coupled to the engine 102, and a drivetrain having a drive shaft coupled to the transmission 124. The engine 102 may be oriented either in lateral orientation (FIG. 11) or in a longitudinal orientation (FIG. 12). In the lateral orientation of FIG. 11, a crankshaft (not shown) extends laterally or generally transverse to the centerline C_{L}, whereas, in the longitudinal orientation of FIG. 12, the crankshaft (not shown) extends parallel to or colinear with centerline C_{L}.

The engine 102 of powertrain assembly 100 may be placed in the vehicle 10 in a plurality of different configurations, with the present application illustrating at least two of these different configurations. In the first illustrative configuration, shown in FIG. 11, the engine 102 is positioned in the vehicle 10 in a lateral orientation, where the cylinders 114 of the engine 102 are aligned from a right side 2 of the vehicle 10 to a left side of the vehicle 10 and the crankshaft (not shown) extends laterally between the right side and left side of the vehicle 10 such that the engine 102 is perpendicular to a centerline C_{L} of the vehicle 10. When the engine 102 is in the lateral orientation, the engine intake manifold assembly 120, which includes an intake manifold 129, at least one throttle body 130, and/or intake manifold runners 132, is positioned generally forward of the engine 102 and rearward of the seating area 20 such that a majority of engine intake manifold assembly 120 is between seating area 20 and a forwardmost point of the engine 102 and all of engine intake manifold assembly 120 is longitudinally between the seating area 20 and a centerline E_{L} of the engine 102. The centerline E_{L} of the engine 102 is defined, in the first illustrative embodiment, as the laterally-extending centerline of the cylinders 114 such that the centerline E_{L} intersects the midpoint or the vertically-extending reciprocation axis (e.g., reciprocation of a piston (not shown) therein) of each cylinder 114.

The exhaust assembly 108 of the first illustrative configuration (FIG. 11), which includes an exhaust manifold 134, at least one exhaust conduit 136, and/or a muffler or silencer 138, is positioned generally rearward of the engine 102 and forward of a rear of the vehicle 10 such that at least the exhaust manifold 134 and muffler 138 of the exhaust assembly 108 are longitudinally between the engine 102 and the rearward most point of the vehicle 10. It may be appreciated that a portion of a tail pipe of the exhaust assembly 108 may extend rearwardly from the rear of the vehicle 10 without departing from the description and understanding of the exhaust assembly 108 disclosed herein.

The transmission 124 of the first illustrative configuration (FIG. 11) is laterally positioned between the engine 102 and the right side or left side of the vehicle 10 such that the transmission 124 extends along a right side or a left side of the engine 102. The transmission 124 also may be positioned rearward of at least a portion of the engine intake manifold assembly 120 and forward of at least a portion of the exhaust assembly 122. Illustratively, the transmission 124 is positioned laterally between the engine 102 and the left side 4 of the vehicle 10.

The configuration of the powertrain assembly 100 of the first illustrative configuration (FIG. 11) allows for the powertrain assembly 100 to have a hot side and a cold side. More particularly, a hot side of the engine 102, or the side of the engine 102 which contains more heat producing components, is generally defined as the rearward portion of the engine 102 (e.g., may be defined as the portion of at least the engine 102 positioned rearward of the engine centerline E_{L}). The hot side of the engine 102 includes heat-producing components such as the exhaust manifold 134 which contains hot air exhaust from the engine 102 and other such components that may experience elevated temperatures during operation of the engine 102 compared to other components. Additionally, a cool/cold side of the engine 102, or the side of the engine 102 which generates less heat, is generally defined as the forward portion of the engine 102 adjacent the seating area 20 (e.g., may be defined as the portion of at least the engine 102 positioned forward of engine centerline E_{L}). The cool side of the engine 102 includes components that generate no or less heat such as the engine intake manifold assembly 120 which receives ambient air and other such components that do not experience elevated temperatures during operation of the engine 102. Because the cool side of the engine 102 does not generate heat or generate as much heat as the hot side of the engine 102, various heat sensitive components of the powertrain assembly 100 and/or the vehicle 10 may be positioned within or adjacent to the cool side of the engine 102, such as electronics like sensors, controllers, etc. In addition to the strategic positioning of a hot and cold side of the engine 102, this first illustrative configuration allows for throttle body 130 to be closer to the intake manifold 129 resulting in a shorter engine intake manifold assembly 120.

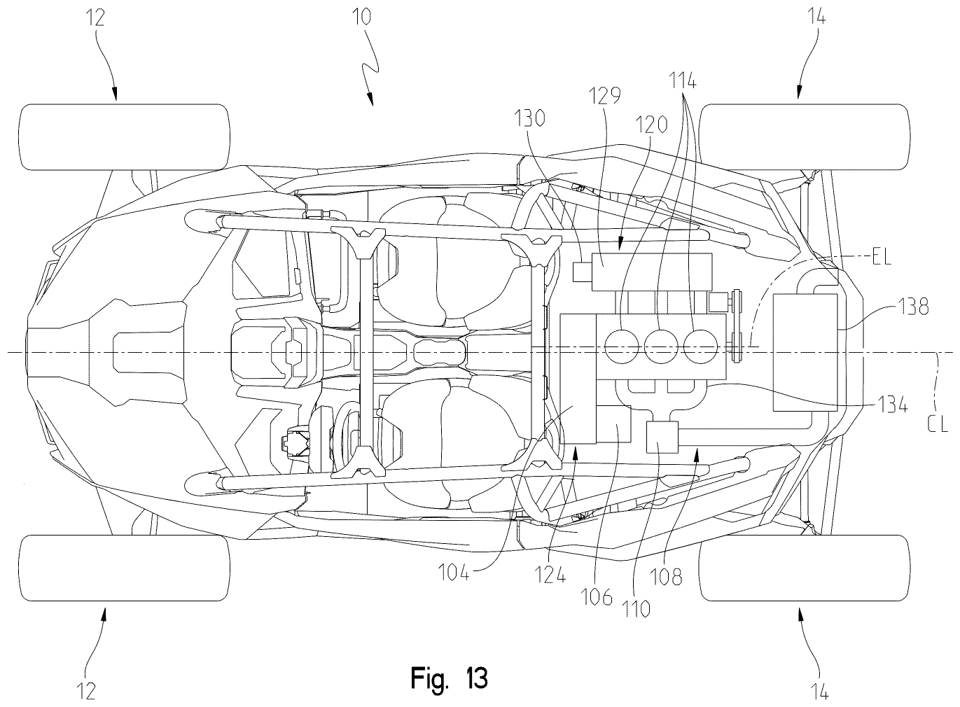

In the second illustrative configuration, shown in FIGS. 12 and 13, the engine 102 is positioned in the vehicle 10 in a longitudinal configuration, where the cylinders 114 of the engine 102 are aligned in the fore/aft direction of the vehicle 10 and the crankshaft 116 extends longitudinally such that engine centerline EL of the engine 102 may be at least parallel to centerline C_{L} of the vehicle 10. In other embodiments, the engine centerline E_{L} may be colinear with the centerline C_{L}. As shown in FIGS. 12 and 13, when the engine 102 is in the longitudinal/second illustrative configuration, longitudinal centerline E_{L} of the engine 102 may be offset to the right of the centerline C_{L} of the vehicle 10 in order to allow an output shaft (not shown) of shiftable transmission 106 and the drive shaft (not shown) of the drivetrain to be properly aligned. When the engine 102 is in the second or longitudinal configuration, the engine intake manifold assembly 120 is positioned laterally between the right side of the vehicle 10 and the engine 102, portions of the exhaust assembly 122 extend along the left side of the vehicle 10 to a position rearward of the engine 102, and the transmission 124 may be positioned longitudinally forward of the engine 102. In various embodiments, at least a portion of the transmission 124 may be positioned below the seating area 20 and/or rearward of the seating area 20. As such, the transmission 124 may be longitudinally intermediate a portion of the seating area 20 and a portion of the engine 102.

In either the first or second illustrative configurations, the powertrain assembly 100 may further include the turbocharger 110, which may be positioned behind the engine 102 in the transverse configuration of FIG. 11 or behind or to the side of the engine 102 in the longitudinal configuration of FIGS. 12 and 13. However, in various embodiments, the turbocharger 110 may be positioned at any location along exhaust conduit 136 between the exhaust manifold 134 and muffler 138. In some embodiments, the turbocharger 110 may be integrated within a portion of the exhaust manifold 134 and/or positioned immediately adjacent the exhaust manifold 134. The exhaust manifold 134 may include a run that is less than 12 inches, for example, less than 9 inches, less than 6 inches, less than 4 inches, less or than 2 inches. This places the turbocharger 102 in close proximity to the engine 102, for example the space between the turbocharger 110 and the engine 102 may be less than 9inches, less than 6 inches, less than 5 inches, less than 4 inches, less than 3 inches, less than 2 inches, or less than 1 inch. Be having the run between the engine 102 and the turbocharger 110 being shortened, the responsiveness of the turbocharger 110 is increased. The configuration of the inlets and outlets of the turbocharger 110 discussed below also facilitates the placement of the turbocharger 110 in such close proximity with the engine 102.

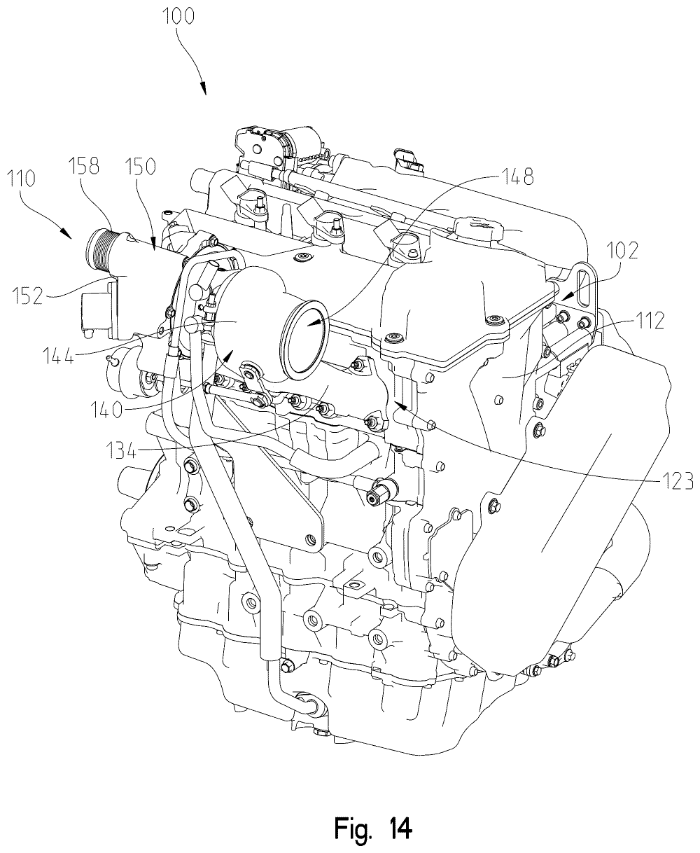

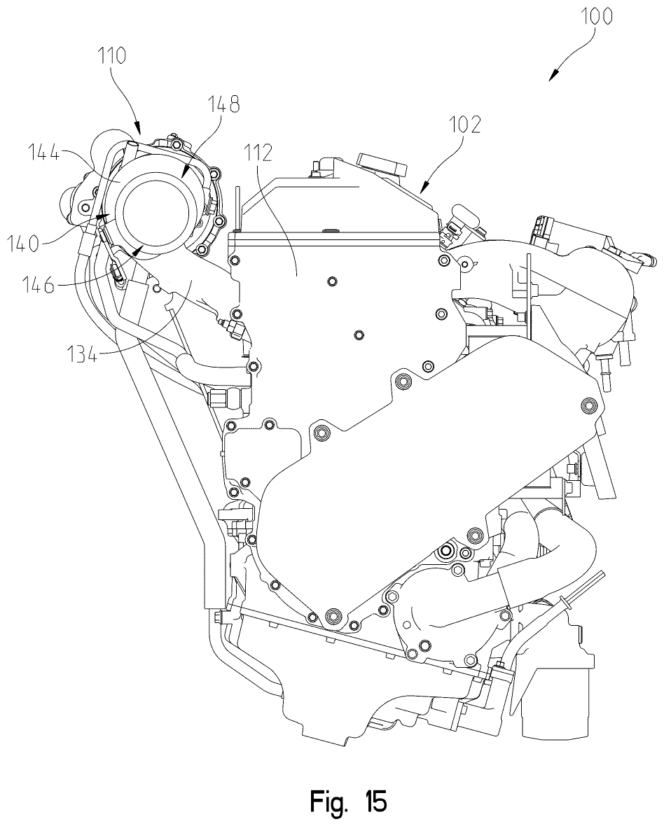

Referring to FIGS. 14-17, the turbocharger 110 is positioned on the hot or exhaust side of the engine 102 and is in parallel with the engine 102. When the engine 102 is provided in the East/West configuration, the turbocharger 110 is positioned rearward of the engine 102. The turbocharger 110 is coupled to the engine block 112. It is understood that the turbocharger 110 may be provided as a single integral unit with the exhaust manifold 134 or may be provided as a separate component that can be coupled to the exhaust manifold 134. Accordingly, in some embodiments, the turbocharger 110 is coupled to the engine block 112 via the exhaust manifold 134 which is separate from the turbocharger 110 or in some embodiments is coupled to the engine block 112 via the exhaust manifold 134 that is integral with the turbocharger 110. The turbocharger 110 is in fluid communication with the exhaust ports 123 of the engine 102. Various turbochargers may be implemented, including but not limited to those shown in U.S. Pat. No. 10,300,786 issued May 28, 2019 and entitled “Utility Vehicle”, the subject matter of which is incorporated herein by reference in its entirety. In some embodiments, the exhaust manifold 134 includes a short run from the engine 102 to the turbocharger 110 (e.g., less than one foot, such as less than 8 inches or less than 6 inches). By having a shorter run from between the turbocharger 110 and the engine 102, other air delivery components such as the second and third conduits 168, 172 (which are discussed hereafter) have shorter segments exposed to the hot side of the engine 102 and therefore heat transfer is limited to those components which deliver air to the engine for combustion.

The turbocharger 110 includes a turbine portion 140 and a compressor portion 150. The turbine portion 140 includes a turbine housing 142, a turbine (not shown), a turbine inlet 146, and a turbine outlet 148. In some embodiments, the turbine inlet 146 receives exhaust from the exhaust manifold 134 (e.g., the turbine inlet 146 is coupled to the exhaust manifold 134 or is integral with the exhaust manifold 134). The compressor portion 150 includes a compressor housing 152, a compressor (not shown), a compressor inlet 156, and a compressor outlet 158. A shaft (not shown) extends between turbine and the compressor.

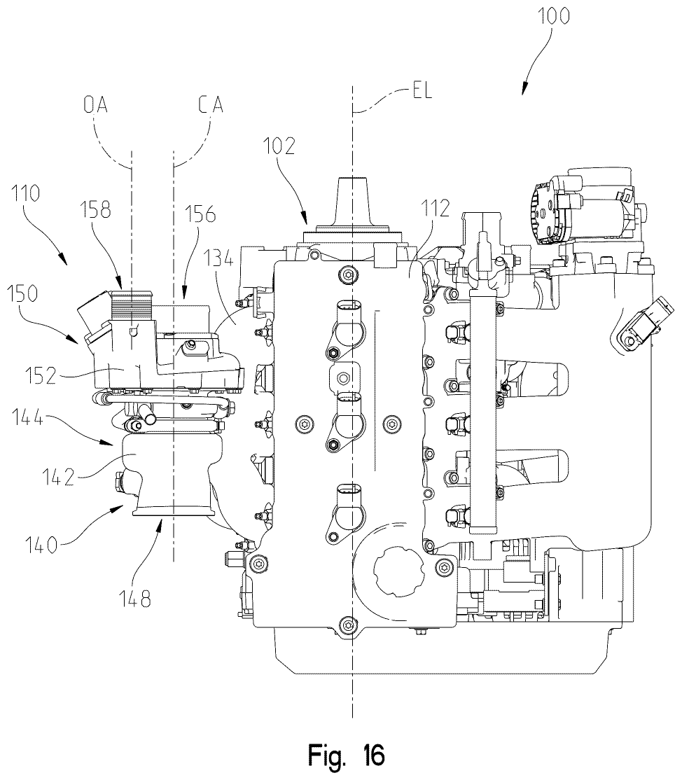

As shown in FIG. 16, the compressor outlet 158 is aligned parallel to the engine centerline E_{L}. The compressor inlet 156 is also aligned parallel to the engine centerline E_{L}. By aligning the compressor inlet and outlet 156, 158, the turbocharger 110 includes a narrower profile extending away from the engine 102. For example, when the engine 102 has an East/West configuration, the turbocharger 110 includes the compressor inlet and outlet 156, 158 each facing towards the left side of the vehicle 10 (FIG. 8). This reduces the profile of the turbocharger 110 in the longitudinal direction of the vehicle 10 when installed. The compressor inlet and outlet 156, 158 are positioned on the same side of the compressor housing 152. For example, the compressor inlet 156 may be positioned along or near a center of a side of the compressor housing 152 (e.g., along a compressor axis C_{A} of the compressor 154, see FIG. 16) and the compressor outlet 158 is positioned at the periphery of the side of the compressor housing 152 (e.g., at an outer edge of the compressor 154 having an outlet axis O_{A} that is substantially parallel to the compressor axis C_{A}). Furthermore, by placing the compressor inlet and outlet 156, 158 as described, thermal transfer of the turbocharger 110 and its corresponding components (e.g., conduits) is reduced. By having the compressor inlet 156 and the compressor outlet 158 parallel to each other, both the compressor inlet and outlet 156, 158 extend laterally away from the engine 102 and therefore are oriented to limit heat transfer to the conduits which couple to each of the compressor inlet and outlet 156, 158. This also facilitates the close placement of the turbocharger 110 with the engine 102 as described above.

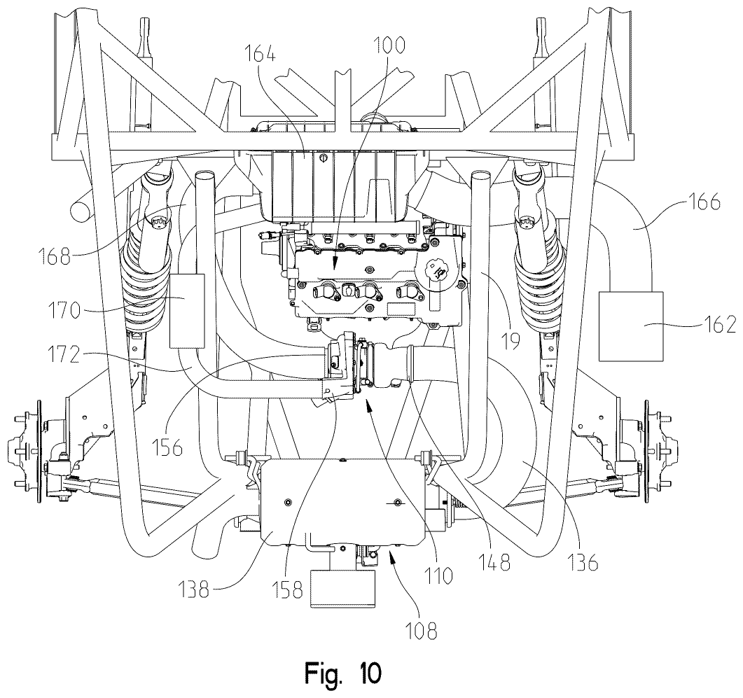

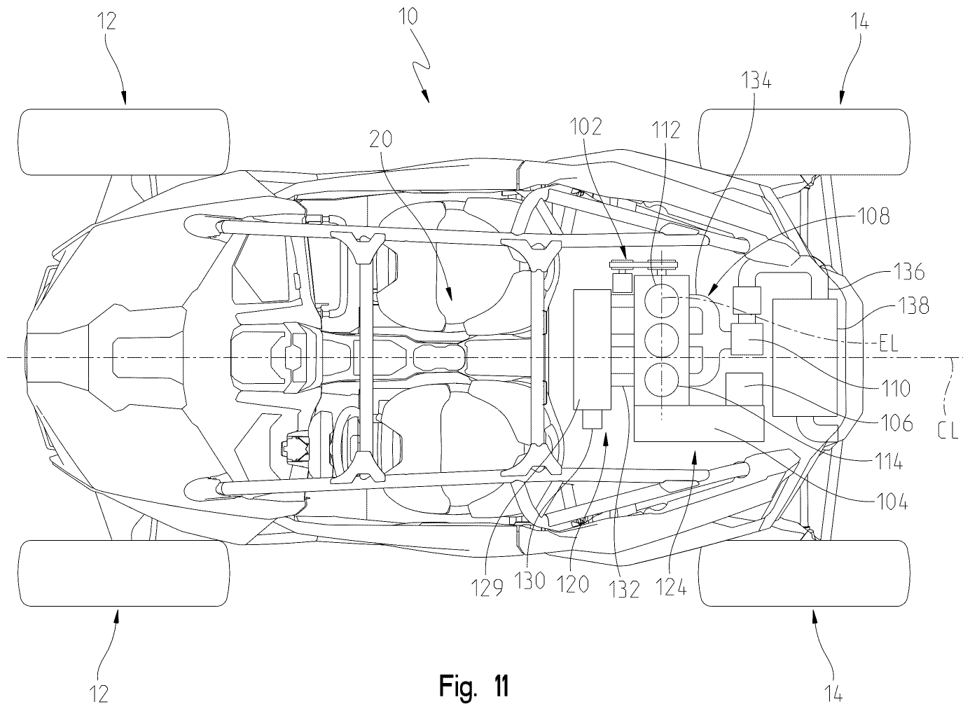

More specifically, by placing the compressor inlet and outlet 154, 156 as shown and described (e.g., FIGS. 10 and 16), the conduits through which the air is travelling have a shortened length and their exposure to the hot side of the engine 102 is reduced. Referring to FIGS. 8-10, for example, the vehicle 10 may include an air intake system 160 that includes an air intake inlet 162, an air filter 164, a first conduit 166 extending between the air intake inlet 162 and the air filter 164, a second conduit 168 extending between the air filter 164 and the compressor inlet 156, an intercooler 170, a third conduit 172 extending between the compressor outlet 158, and a fourth conduit 174 extending between the intercooler 170 and the engine intake manifold assembly 120. The second and third conduits 168, 172 are short segments on the hot side of the engine 102 in order to reduce thermal transfer to the air that moves through those conduits. For example, the portions of the second and third conduits 168, 172 that are positioned on the hot side of the engine 102 are less than two to three feet, including less than one foot. Because the turbocharger 110 includes shorter conduits (e.g., first, second, third, and fourth conduits 166, 168, 172, 174), and because the turbocharger 110 is arranged to include a compact profile (e.g., the alignment of the compressor inlet and outlet 156, 158), the turbocharger 110 is able to limit thermal transfer and therefore increase the thermal efficiency of the turbocharger 110 and the powertrain assembly 100, generally.

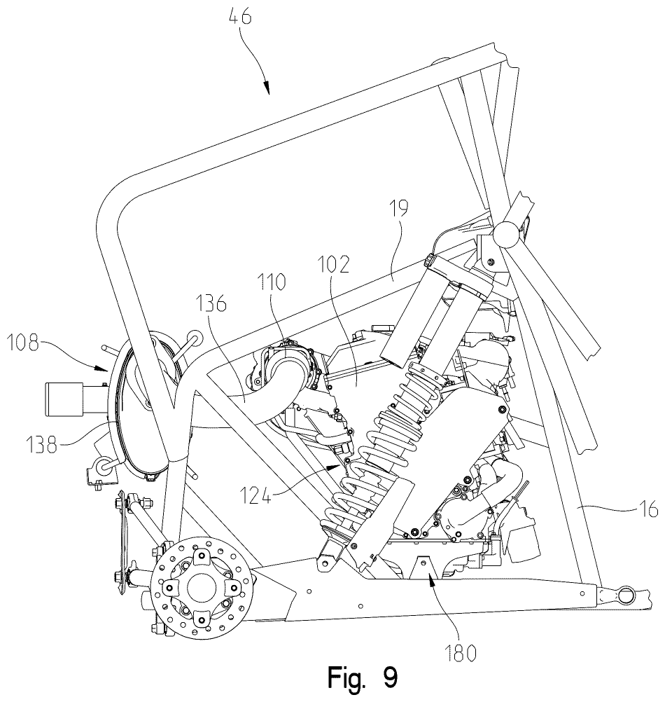

Referring again to FIGS. 8-10, the turbocharger 110 is packaged within the vehicle 10 in order to optimize the ability of the powertrain assembly 100 to deliver power to the ground-engaging members 12, 14. As illustrated in FIG. 9, the turbocharger 110 is positioned longitudinally rearward of the engine 102, vertically below the cargo area 46, longitudinally forward of the muffler 138, vertically above at least a portion of the transmission 124, laterally adjacent to the CVT 106 (see FIG. 11), and laterally between rear frame members 19. The turbocharger 110 is positioned below and spaced from the cargo area 46 such that it is not contacting or directly adjacent to the cargo area 46 to limit heat transfer to the cargo area 46 (e.g., when a utility bed includes a plastic body) and outside of an envelope formed by the CVT 106. The turbocharger 110 is protected between the rear frame members 19 and is also positioned spaced from the rear ground-engaging members 14 and an envelope defined by the rear ground-engaging members 14. As illustrated, the exhaust conduit 136 is coupled to the turbine outlet 148 and extends to the muffler 138. In some embodiments, the exhaust conduit 136 is routed to the muffler 138 such that at least a portion of the exhaust conduit 136 extends beyond (e.g., outboard of) one of the rear frame members 19. Thus, the turbocharger 110 is positioned within a frame envelope defined by the rear frame members 19 envelope and the exhaust conduit 136 extends at least partially outside of the frame envelope. In some embodiments, the turbocharger 110 is within 4 feet (e.g., within 2 feet) of the rear suspension 42. The turbocharger 110 may be packaged inboard of the rear suspension 42, the positioning being operable to mitigate heat transfer to the components of the rear frame members 19 and the rear suspension 42.

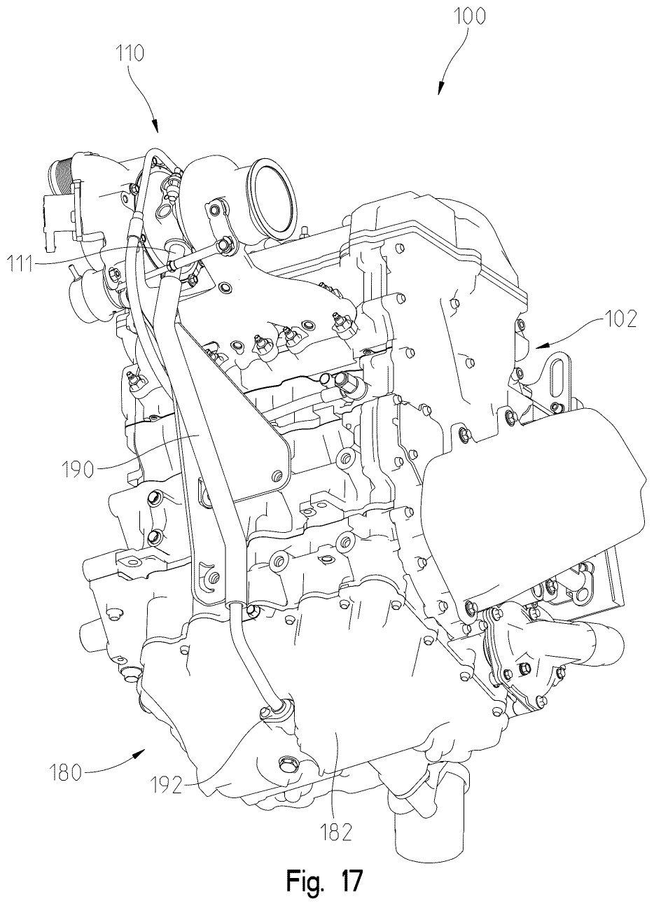

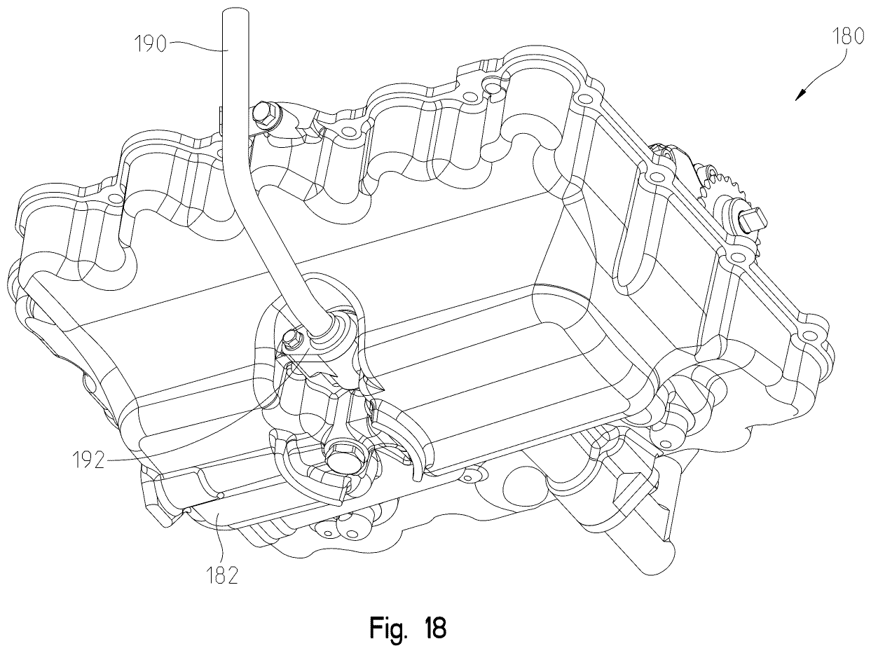

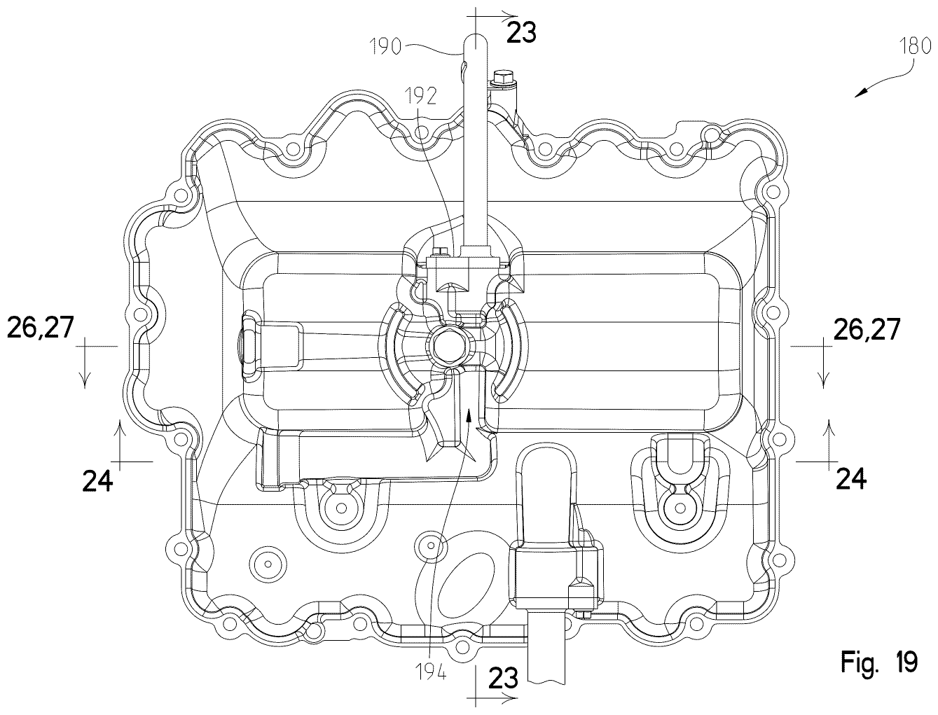

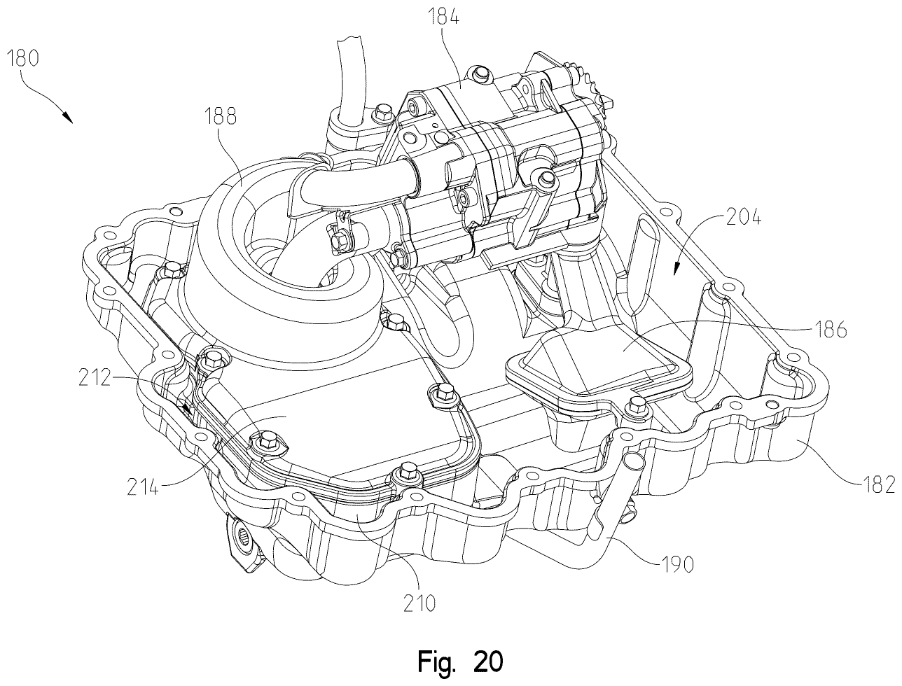

Referring now to FIGS. 17-29, the powertrain assembly 100 also includes an oil management system 180. The oil management system 180 includes an oil pan 182 coupled to the engine 102 (FIGS. 17-20), an oil pump 184 (FIG. 20), at least one oil pickup member 186 (FIG. 20), and a deaerator 188 (FIG. 20). The oil pan 182 defines at least one reservoir into which oil is drained. Oil that is in the reservoir is pumped from the reservoir, through the oil pickup member 186 via the oil pump 184, and into the engine 102 (e.g., a wet sump). The reservoir is also operable to receive oil drained from the turbocharger 110. For example, the turbocharger 110 may include a drain 111 that is coupled to an oil drain line 190 that coupled to an oil drain line connector 192 on the oil pan 182 (FIG. 20). The drain line connector 192 includes a channel 194 through which oil drains from the turbocharger 110 into the reservoir of the oil management system 180.

The oil pan 182 with the turbo drain line connector 192 allows the turbocharger 110 to continue to operate in conditions of high vehicle angularity. For example, the turbocharger 110 will continue to drain in conditions of 50 degree and greater angularity of the vehicle 10, which can be caused in certain operating conditions of the vehicle 10 including climbing, rock crawling, accelerations, and so forth. The turbocharger 110 will continue to drain into the oil pan 182 in the high angularity conditions because a low pressure zone is formed where the oil from the turbocharger 110 is drained in the oil management system 180. In some embodiments, the oil pan 182 includes a deep profile that is facilitated, in part, by the raising of the engine 102 from the frame 16, which is discussed more fully in U.S. patent application Ser. No. 16/875,494, which is incorporated by reference herein. By having a deeper profile, the oil pan 182 and reservoir are able to hold oil even when the vehicle 10 is in high angularity and/or high acceleration situations (e.g., longitudinal, lateral, and compound angularity). The angle of the drain lines (i.e., the drain line connector 192 and channel for the turbocharger 110) may be angled relative to a vertical axis such that even at high angularity or acceleration, oil does not travel backward through the oil management system 180.

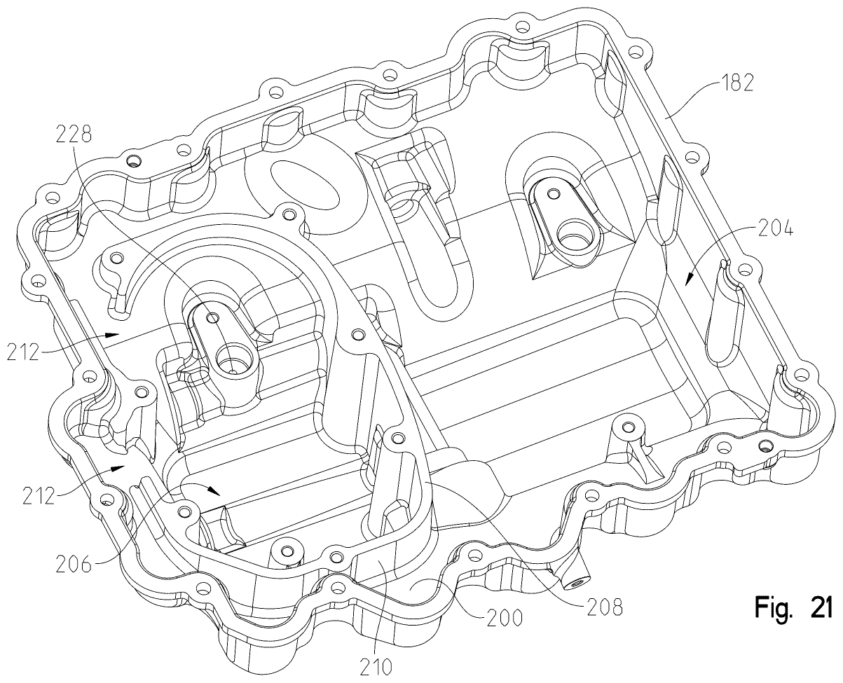

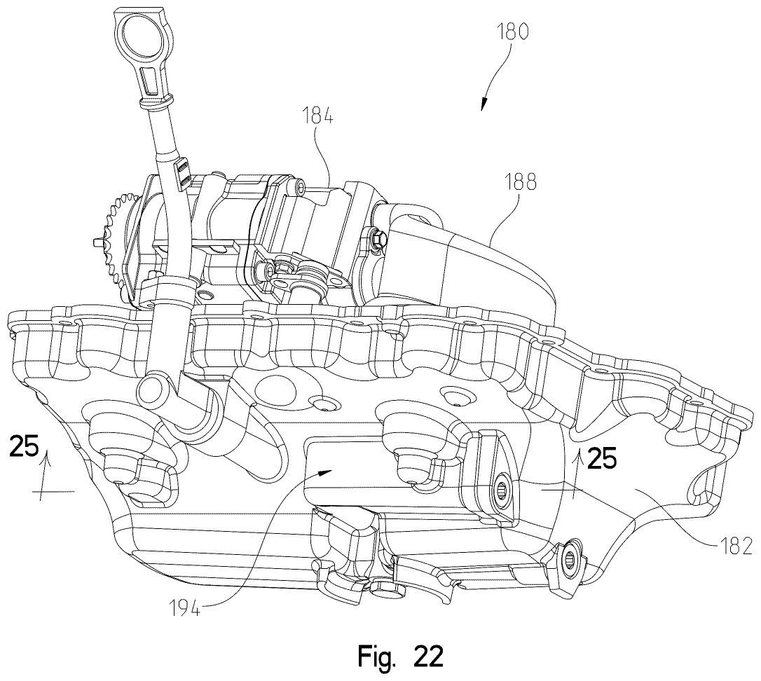

Referring to FIG. 21, the oil management system 180 including the oil pan 182 includes a pan bottom 200 and outer side walls 202. The oil pan 182 defines a staging reservoir 204 and a delivery reservoir 206 and are separated from each other by a wall 208. The oil pan 182 is formed such that oil from the engine 102 drains into and pools in the staging and delivery reservoirs 204, 206. In some embodiments, the oil pan 182 is formed to direct oil substantially to the staging reservoir 204 by including an interior side wall 210 that extends substantially around the delivery reservoir 206. The pan bottom 200 and the interior side wall 210 are formed to facilitate oil draining and pooling to the staging reservoir 204. The interior side walls 210 may include gaps 212 that allow the oil to drain or enter into the delivery reservoir 206, however, the majority of the oil draining into the oil pan 182 from the engine 102 will be directed to the staging reservoir 204 when the engine 102 is in a neutral orientation (i.e., not on an incline, etc.). Referring to FIG. 20, the delivery reservoir 206 is covered with a covering member 214 which allows the delivery reservoir 206 to retain oil supply to the engine 102 during certain angularity operations. The covering member 214 couples to the interior side wall 210 to form the partially pressurized chamber. It is noted that the gaps 212 in the interior side walls 210 are not sealed by the covering member 214, thus allowing oil to enter or exit the delivery reservoir 206 through the gaps 212. In some embodiments, the gaps 212 are positioned on one side of the interior side walls 210 which facilitates the delivery reservoir 206 to retain oil supply to the engine 102 during certain angularity operations (e.g., when the vehicle 10 is angled in such a way that the gaps 212 are vertically higher than other portions of the interior side walls 210).

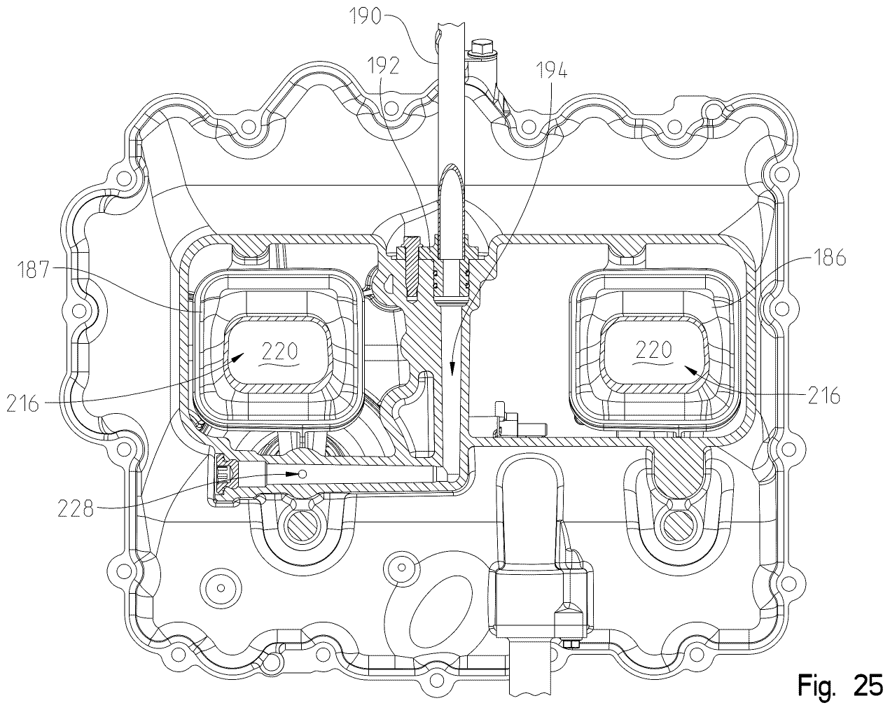

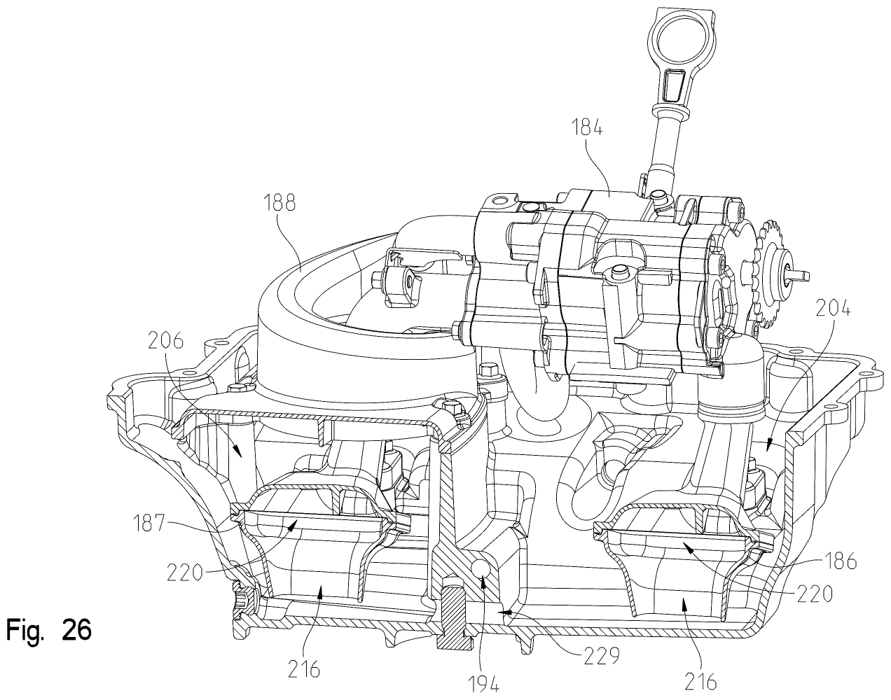

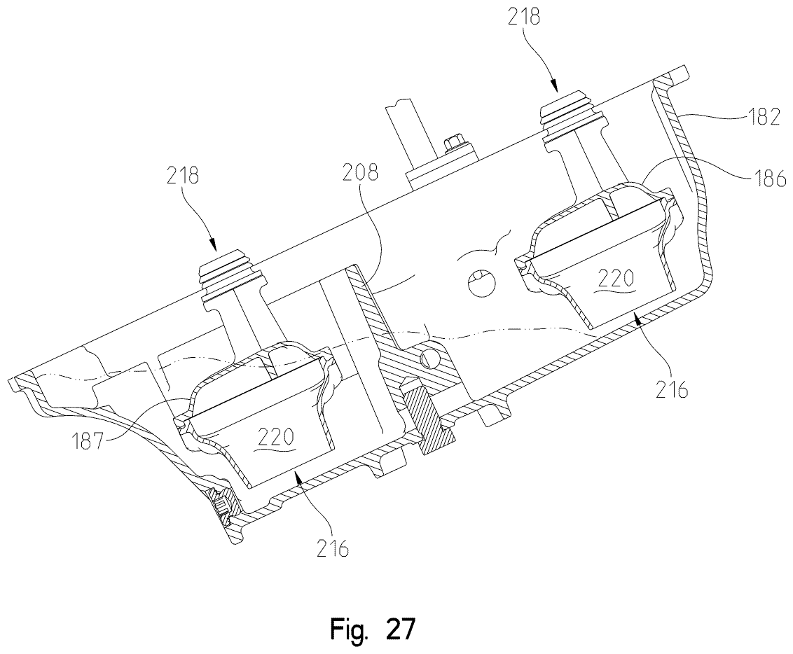

Referring to FIG. 20, the oil management system 180 includes a first pickup member 186 that is positioned with the staging reservoir 204 and a second pickup member 187 positioned with the delivery reservoir 206 (see FIG. 25). The first and second pickup members 186, 187 are operable to uptake oil that is positioned in the respective reservoirs 204, 206. Each of the oil pickup members 186, 187 may include a first opening 216 and a second opening 218 and a main lumen 220 defined within the oil pickup members 186, 187 (see FIG. 26). Oil is picked up by the oil pickup members 186, 187 at the first opening 216 by creating a lower pressure zone in the lumen of the oil pickup members 186, 187 (e.g., via the oil pump 184 which is in fluid communication with the oil pickup members 186, 187 by way of the second opening 218). The oil picked up by the first pickup member 186 is ejected from the oil pump 184 into the deaerator 188 which includes a spiral profile. The deaerator 188 removes air that may have been introduced into the oil collected in the staging reservoir 204 when taken up by the first oil pickup member 186. This may also occur when the first opening 216 of the oil pickup member 186 is not submerged in oil (e.g., when the vehicle 10 is in configurations of high angularity such as when climbing, etc.) (see FIG. 27). The deaerator 188 receives oil from the oil pump 184 and the oil travels through the deaerator 188 around a spiral portion 189 which forces air from the oil, and the deaerated oil is dumped into the delivery reservoir 206. Oil can then be picked up by the second pickup member 187 and cycled back through the appropriate mechanical systems of the powertrain assembly 100 (e.g., the engine 102 and turbocharger 110).

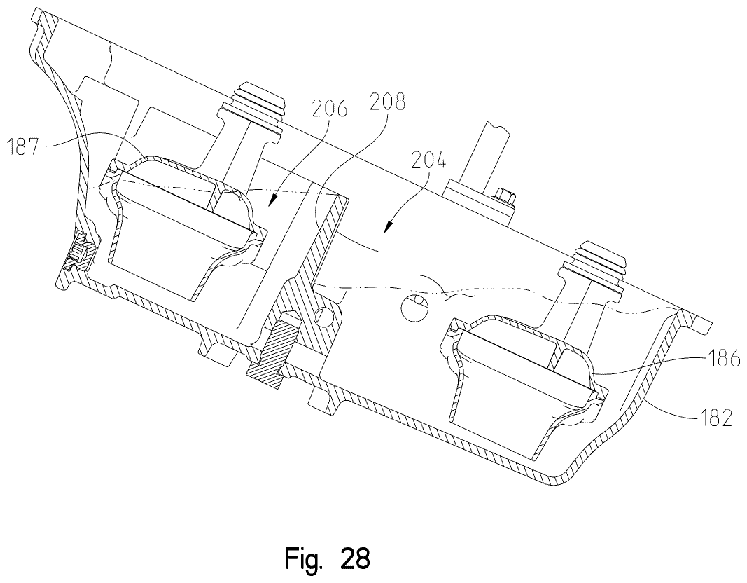

Referring to FIGS. 27 and 28, the oil management system 180 is shown in positions of high angularity. FIG. 27 depicts the oil management system 180 in a position such that the delivery reservoir 206 is in a vertically lower position than the staging reservoir 204. When this occurs, the first opening 216 of the first oil pickup member 186 may not be submerged in oil and thus may pick up both oil and air from the staging reservoir 204. Oil from the staging reservoir 204 is transferred to the delivery reservoir 206 via the deaerator 188. Oil is picked up from the delivery reservoir 206 via the second pickup member 187 and delivered to the engine 102. When the vehicle 10 is in a position that places the oil management system 180 in the configuration shown in FIG. 28, the first opening 216 of the first oil pickup member 186 is submerged in oil and picks up oil from the staging reservoir 204 and transfers it to the delivery reservoir 206. The first opening 216 of the second pickup member 187 remains submerged in oil because the oil being transferred from the staging reservoir 204 to the delivery reservoir 206.

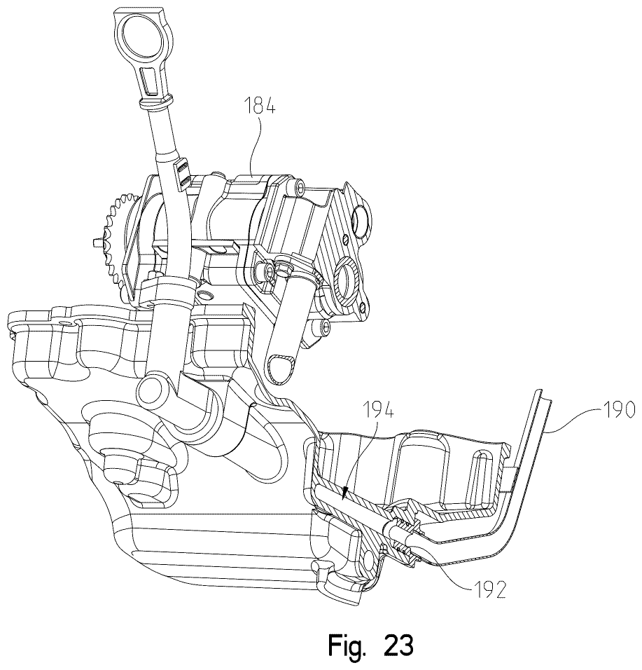

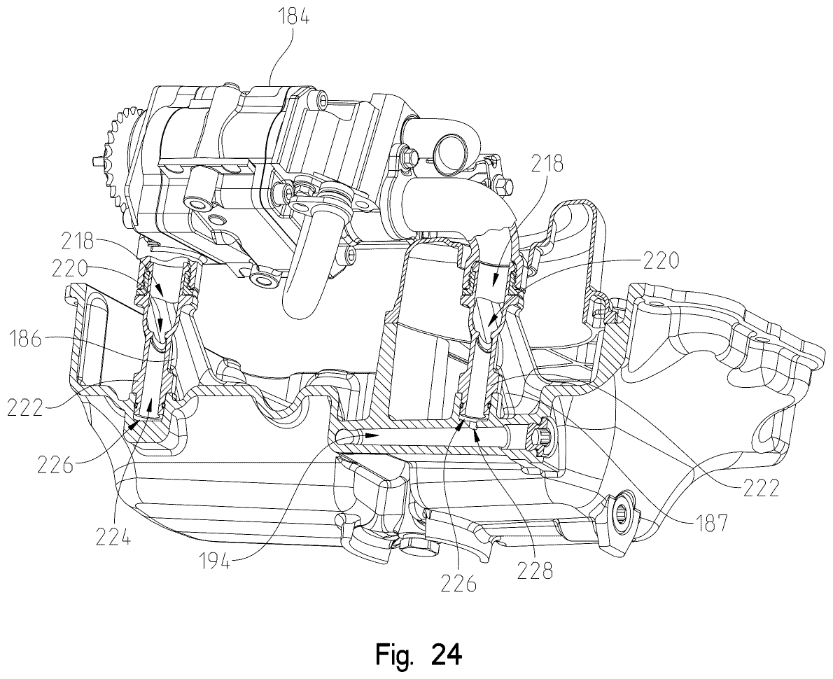

Referring again to FIGS. 23 and 24, the oil pickup members 186, 187 may include an auxiliary arm 222. The auxiliary arm 222 includes an auxiliary lumen 224 and an auxiliary opening 226. The auxiliary lumen 224 is in fluid communication with the main lumen 220. Oil drained from the turbocharger 110 is operable to be drained to a position proximate the auxiliary opening 226 of the oil pickup members 186, 187 such that the oil is picked up at the auxiliary opening 226 and travels through the auxiliary lumen 224 into the main lumen 220. This allows oil to be drained directly from the turbocharger 110 and picked up without pooling in the reservoirs 204, 206. The low pressure zone formed at the auxiliary opening 226 of the oil pickup members 186, 187 pulls the oil through and reduces clogging or backup of oil in the oil drain line 190 and channel 194 of the drain line connector 192. For example, in one embodiment, the channel 194 of the drain line connector 192 can extend through the oil pan 182 (or in other embodiments through another conduit separate from the oil pan 182) to a position proximate the auxiliary opening 226 of the oil pickup members 186, 187. In another embodiment the channel 194 of the drain line connector 192 may drain into one of the reservoirs 204, 206. These embodiments are discussed in more detail herein.

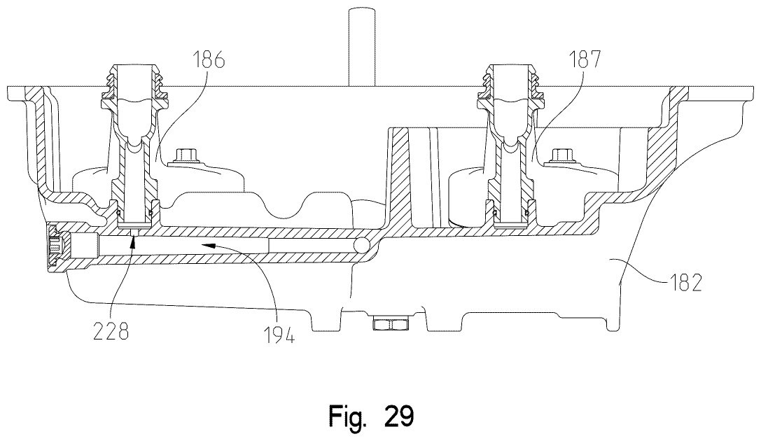

Referring to the embodiment in which the channel 194 of the drain line connector 192 extend through the oil pan 182, the channel 194 is integrally formed in the oil pan 182. For example, FIGS. 23-25 depict the channel 194 extending through the pan bottom 200. An orifice 228 is provided proximate the channel 194. Oil in the channel 194 can exit the channel 194 at the orifice 228. The auxiliary opening 226 of one of the oil pickup members 186, 187 is positioned at or proximate the orifice 228 such that oil is taken up directly into the oil pickup member. The orifice 228 may be sized to include various diameters, which can result in various velocity of oil being pulled through the orifice 228 and various volumes per unit time being pulled through the orifice 228. In the embodiment depicted, the channel 194 is a pressurized system which allows oil to be pulled through the channel 194 and limits oil from backing up in the oil drain line 190. This is important when the vehicle 10 is in positions of high angularity where a gravity turbo drain system would be backed up and oil would not be able to drain from the turbocharger 110. It is understood that the channel 194 may be formed to fluidly connect with the auxiliary opening 226 of either the first oil pickup member 186 (see FIG. 29) or the second oil pickup member 187 (see FIG. 24).

Referring to FIG. 26, a drain channel 229 may be formed through the wall 208 which connects the staging reservoir 204 and the delivery reservoir 206, the drain channel 229 also extending down through the pan bottom 200. This allows for a single access point when changing the oil of the powertrain assembly 100. As is further depicted in FIG. 26, the channel 194 for the turbo drain line connector 192 extends through the wall 208.

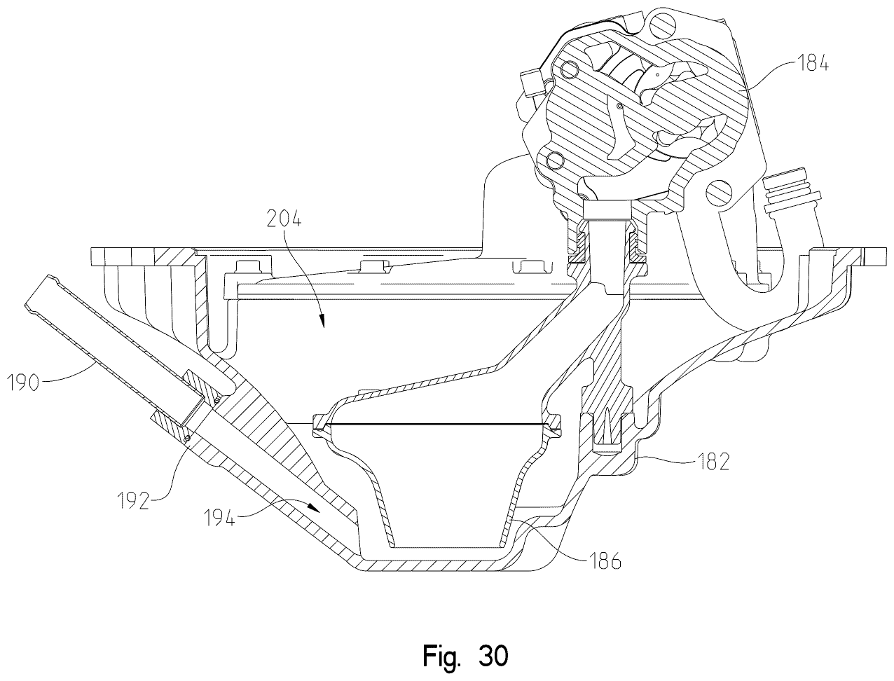

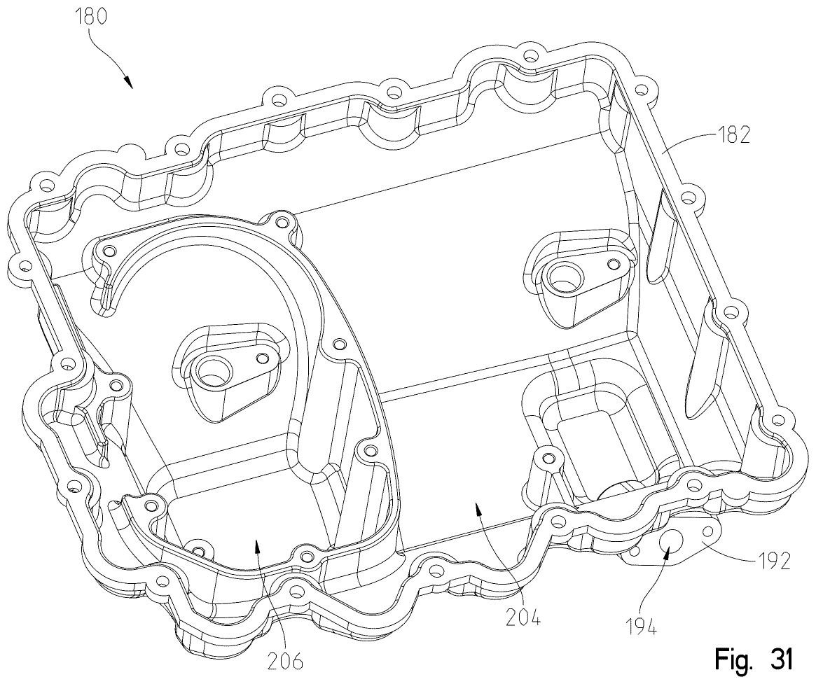

Referring to embodiments in which the channel 194 drains directly into one of the reservoirs 204, 206, in order to reduce clogging or backup of oil in the oil drain line 190 and channel 194 of the drain line connector 192, the oil pickup member 186 is positioned proximate the opening to the channel 194 at the staging reservoir 204 of the oil pan 182 (see FIGS. 30-31). The oil pickup member 186 is in fluid communication with the oil pump 184. Because the opening of the pickup member 186 which receives oil from the staging reservoir 204 is positioned proximate the opening to the channel 194 of the drain line connector 192, a low pressure zone is created in the reservoir 204 which causes oil to be pulled from the channel 194 and into the reservoir 204, from the staging reservoir 204 into the oil pickup member 186, and up into the oil pump 184. This keeps the opening of the channel 194 clear (or maintains movement of oil through the channel 194) and reduces the occurrence of oil backups or clogs from oil draining from the turbocharger 110.

Once the oil from the staging reservoir 204 is picked up, the oil can be recirculated into the engine 102 (e.g., via the deaerator 188). The oil pickup member 186 can be integral with the oil pan 182 or can be a separate member that is coupled to the oil pan 182. For example, is some embodiments, the oil pickup members 186, 187 are formed from a stable polymer that is coupled to the oil pan 182 (e.g., via bolts).

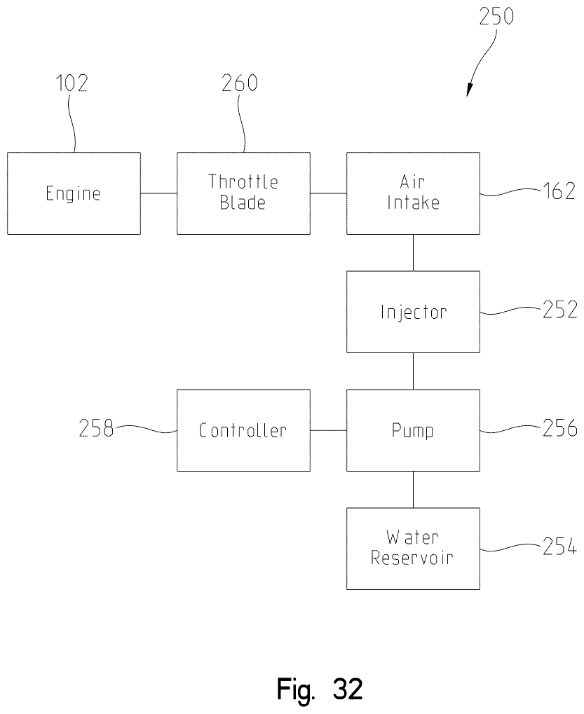

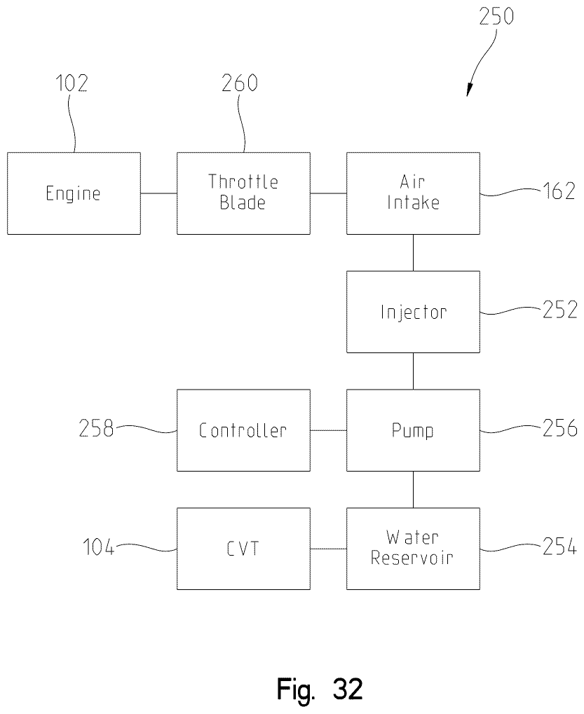

Referring now to FIGS. 32-33, a water injection system 250 is provided with the powertrain assembly 100. More specifically, the water injection system 250 is operable to cool the air intake tract, e.g., the air intake inlet 162. The water injection system 250 includes an injector 252, a water reservoir 254, a pump 256, and a controller 258. The water injection system 250 cools the air intake 162 fluidically prior to a throttle blade 260 of the throttle body 130 (see FIG. 11). In some embodiments, the water injection system 250 interfaces with the air intake 162 (e.g., the injection 252 is positioned with the air intake 162) at a distance of about 5 inches or less from the throttle blade 252 (e.g., 3-4 inches pre-throttle blade). The injector 252 is mounted to the air intake 162 at about a 90 degree angle such that that injector 252 is substantially perpendicular to the flow of air through the air intake 162. The injector 252 is optimized to atomize the water to provide increased surface area for cooling the air intake 162.

By cooling the air prior to the throttle blade 260, only one interface with the air intake inlet 162 is required as the cooled air is distributed to each of the cylinders while allowing the throttle blade 260 to remain close to the cylinders to provide a responsive engagement. The lower intake air temperatures increase the octane rating of the fuel and help sustain the target horsepower. The water injection system 250 is operable to remove heat from the air to provide about a 10-15 degree Celsius temperature drop. The water injection system 250 may be mounted on the frame 16 of the vehicle 10 (e.g., an off road vehicle). The water injection system 250 is positioned on the CVT-side of the powertrain assembly 100.

The water cooling system 250 may be activated in various conditions. For example, the controller 258 may activate based on sensed conditions such as certain operating temperature, increased power demands, and so forth. For example, when the vehicle 10 is being operated in wide open throttle, a predetermined boost threshold is met, the water cooling system 250 is activated and water is pumped through to the injector 252 intake and the water contacting the air intake 162 is operable to remove heat from the air (10-15° C. of temperature drop) flowing into the engine 102. The water is operable to add a high octane level and changes the knock propensity. That decreases the occurrence of the engine 102 de-rating and allows the engine 102 to continue to make power. In some embodiment, the water injection system 250 is operable to initialize in de-rate conditions. This allows the powertrain assembly 100 to maintain higher levels of performance in high temperature internal engine conditions.

In some embodiments, the water injection system 250 and the CVT 104 may be at least partially integrated. For example, controller 258 may be operable to control the operation of the water injection system 250 and operation of the CVT 104. Furthermore, the CVT and the water injection system 250 may be fluidically coupled to the water reservoir 254 (e.g., a common reservoir).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1.-11. (canceled)

12. A utility vehicle, comprising:
a plurality of ground-engaging members;
a frame supported by the ground-engaging members; and
a powertrain assembly supported by the frame and including:
an engine supported by the frame;
a turbocharger operably coupled to the engine; and
an oil management system fluidically coupled to the engine and the turbocharger, the oil management system including an oil pan defining a staging reservoir, a staging oil pick up member including an opening positioned proximate the staging reservoir, an engine oil pump fluidically coupled to the staging oil pick up member and operable to pump oil from the staging reservoir to the engine, and a turbo drain through which oil from the turbocharger is operable to drain from the turbocharger, the turbo drain operable to deliver the oil to be picked up by the staging oil pick up member.

13. The utility vehicle of claim 12, wherein the oil management system is a wet sump.

14. The utility vehicle of claim 13, wherein the staging oil pickup member includes an auxiliary opening, the auxiliary opening being fluidically coupled to the turbo drain.

15. The utility vehicle of claim 14, wherein the oil management system includes a channel in fluid communication with the turbo drain and the staging oil pick up member at the second opening, such that oil is drained from the turbocharger directly to the auxiliary opening of the staging oil pickup member.

16. The utility vehicle of claim 15, wherein the oil management system includes a delivery reservoir adjacent the staging reservoir and a delivery oil pickup member with an opening proximate the delivery reservoir, wherein the oil pump is operable to deliver oil from the staging reservoir to the delivery reservoir.

17. The utility vehicle of claim 16, wherein the oil management system includes a de-aerating member fluidically between the staging reservoir and the delivery reservoir.

18. The utility vehicle of claim 17, wherein the oil management system includes a delivery reservoir cover, wherein the delivery reservoir is a pressurized chamber when the delivery reservoir cover is installed and the oil pump is active.

19. The utility vehicle of claim 18, wherein the staging oil pickup member is positioned vertically above a portion of the staging reservoir.

20. The utility vehicle of claim 12, wherein the portion of the staging reservoir above which the staging oil pickup member is positioned defines a low pressure zone during operation.

21. The utility vehicle of claim 20, wherein the turbocharger drains into the low pressure zone of the staging reservoir.

22.-29. (canceled)
